(19) United States
(12) Patent Application Publication
(10) Pub. No.: US 2004/0177011 A1
(43) Pub. Date: Sep. 9, 2004

(54) Food contamination tracking system

(76) Inventors: Jimmie A. Ramsay, Carriere, MS (US); Shannon L. Ramsay, Picayune, MS (US)

Correspondence Address: BUTLER, SNOW, O'MARA,, STEVENS & CANNADA, PLLC, Post Office Box 171443, Memphis, TN, 38187, US

(21) Appl. No.: 10/382,967

(22) Filed: Mar. 6, 2003

(51) Int. Cl. G06F 17/60

(52) U.S. Cl. 705/28

(57) ABSTRACT

A central computer system is connected to remote computer systems at remote food processing and distribution facilities, receives data from the remote facilities including test results regarding contamination tests performed on food items at the facilities. The computer combines the records of test results and records of food items received from both facilities to track contaminated food in the facilities.

### FIELD OF THE INVENTION

The invention relates to systems for tracking food products. In particular it relates to hub-and-spoke computer systems that track contamination of food products trough a processing and distribution network from a central facility.

### BACKGROUND OF THE INVENTION

Food contamination, whether by chemical or biological materials is a significant problem in the food industry. Tracking contaminated food items through a food processing and distribution networks is often futile and time consuming. Faced with a food emergency, such as an E. coli outbreak, the need for a speed response prevails, and much good food is thrown out with bad food just to ensure that no bad food escapes into the marketplace.

What is needed therefore is a computer-based system for tracking food contamination that receives records in electronic form from several different facilities in the chain of food production. What is needed is a system that, when provided with evidence of contamination such as failed test results, will associate the electronic records received from the several different facilities and create a forward chain of locations to which the tested food item (or food items derived from the tested food items) have been sent. What is needed is a system that will alternatively permit back tracking through the chain of production using those same records to find other food items from which the contaminated food item was derived that might therefore also be contaminated.

It is an object of this invention to provide a system capable of satisfying these requirements in one or more of the embodiments described below.

### SUMMARY OF THE INVENTION

In accordance with a first aspect of the invention, a central computer system is provided that receives electronic records indicative of food items from several different food processing facilities and is configured to forward track through those records. In accordance with a second aspect, a central computer system is provided that receives electronic records indicative of food items from several different food processing facilities and is configured to back track through those records. In accordance with a third aspect, the central computer system may provide backtracking to previous locations of a food item or other food items from which the food item was derived. In accordance with another aspect, the central computer system may permit forward tracking to later locations of the food item or other food items derived from the food item.

In accordance with another aspect, not just the central computer system may be provided, but an entire computing network may be provided including the central computer system and several remote satellite computer systems connected to the central computer system to provide it with the food item data. The remote systems may be located at remote food processing facilities. They may be configured to receive food item data for food items processed at the remote facility and to forward that data to the central computer system.

In accordance with another aspect, the central computer system may be configured to track the subdividing and combining of food items. The data transmitted to the central computer may be derived from identification or other data scanned from tags such as bar code tags or RFID tags. This scanned data may be scanned at the remote facilities and transmitted from the remote facilities to the central computer system. The bar code tags and the RFID tags may be attached to or embedded in the food items processed at the remote facilities.

### BRIEF DESCRIPTION OF THE DRAWINGS

FIG. 1 illustrates a food distribution and processing network that includes a central computing facility and several satellite food processing and distribution facilities.

FIG. 2 illustrates the central processing facility of FIG. l, showing the computer system at the central facility in detail.

FIG. 3 illustrates a typical one of the remote processing and distribution facilities, showing the computer system at the facility in greater detail.

FIG. 4 illustrates a vehicular remote facility showing its computer system in greater detail.

FIG. 5 is a detailed view of the RDS system that is employed by and maintained in each of the remote facilities and the central facility.

FIG. 6 is a flow chart illustrating a beef production and distribution process wherein a cow is turned into scraps and prime cuts in a slaughterhouse and the scraps are sent to a grinding facility.

FIG. 7 is a flow chart illustrating a beef production and distribution process wherein the scraps of FIG. 6 are converted into ground beef patties and are sent to a distribution facility.

FIG. 8 is a flow chart illustrating the process of receiving data from the remote satellite facilities and processing in, including the steps of determining whether there is contamination, backtracking and forwardtracking through the data, as well as displaying in a computer display screen.

FIG. 9 is an illustration of a computer display screen that is configured to display the forward tracking of food items of the production and distribution process of FIGS. 6 and 7 performed by the central computer.

FIG. 10 is an illustration of the computer display screen of FIG. 9 in its alternative configuration to display the backtracking of food items of the production and distribution process of FIGS. 6 and 7.

FIG. 11 is yet another illustration of the computer display screen of FIGS. 9-10 in yet another configuration showing its capability and the capability of the central computer that drives it to backtrack and display multiple joined chains of food items.

### DETAILED DESCRIPTION OF THE PREFERRED EMBODIMENTS

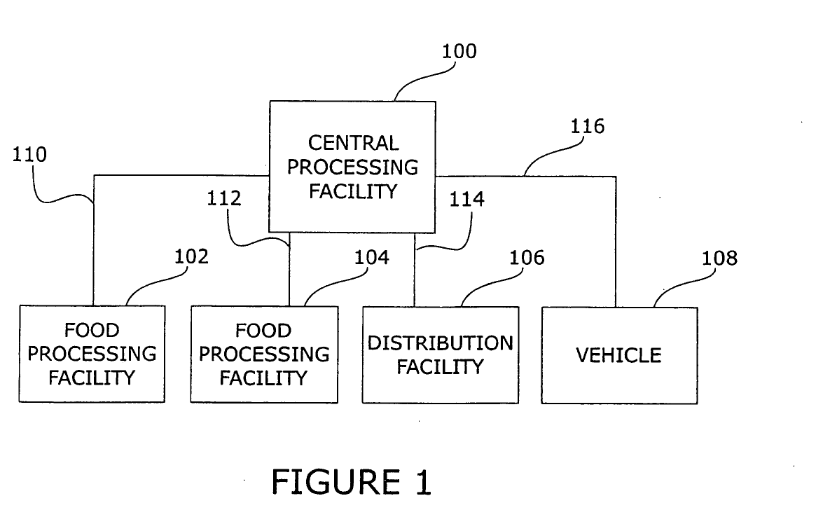

FIG. 1 illustrates a food distribution and processing network that includes a central computing facility 100 and several satellite food processing and distribution facilities 102, 104, 106 and 108. Electronic data regarding food items processed at each facility may be provided to the central processing facility 100 by telecommunications links 110, 112, 114, and 116 which extend between each of the facilities 102, 104, 106, and 108, and facility 100.

The food processing and distribution facilities may be fixed, such as 102, 104, and 106, or they may be moveable, such as vehicle 108. They are processing and distribution facilities for the processing and distribution network that comprises all the facilities, combined. Each of facilities 102 and 104 is a facility for growing, processing or packaging food items, such as meat, and in particular, beeves, beef, and beef byproducts. Processing facilities 102 and 104 may be farms, fields, ranches, feedlots, sale yards, slaughterhouses, processing houses, rail yards, port facilities, and marshalling yards, restaurants, grocery stores, and supermarkets or a combination of them.

While FIG. 1 illustrates two such facilities 102, 104, we anticipate many more than the two shown here, but all of them similarly linked by telecommunications to central facility 100. In the case of a full-blown system for beef production overseas, the facilities might include a ranch where the cattle are raised, a first sale yard where the calves are sold, a second ranch where they are fattened up, a second sale yard, a feedlot where the cattle, now grown, are brought to be finished, a third sale yard, and slaughterhouse where they are slaughtered and converted into sides, a processing facility where the sides or quarters are divided into prime cuts and the rest, a ground beef processing facility in which the rest of the beeves (i.e. the non-prime portions) are converted into ground beef patties, a distribution warehouse where the ground beef is stored, a port facility or rail yard at which the beef is held and prepared for shipment, a similar rail yard or port facility at the shipping destination, a second distribution facility to hold the beef prior to distribution to restaurants and grocery stores, and, finally, the restaurants and grocery stores themselves. Thus, the facilities 102, 104 represent the two or more places where the food items exist during this process.

The facilities 102 and 104 may be completely unrelated facilities or groups of facilities, such as facilities that process grain (in one group) and facilities that process beeves (in a second group). By unrelated, we mean that individual groups of facilities that are connected to central facility 100 are not on the same food processing and distribution paths. In other words, of all the processing and distribution facilities linked to central facility 100, there may be several groups for receiving and processing one type of food, and that send and receive food items from each other, and there may also be several facilities that receive and process a different type of food and never send or receive food items of any of the first group of facilities.

In a similar fashion, within a group of facilities that process a particular type of food, there may be several facilities, such as several ranches, that send food to one or more different sale yards, that in turn send food to one or more different slaughterhouses, that send food to one or more different processing facilities. In other words, while all the facilities 102, 104 are linked to central facility 100, they themselves may appear as a web of nodes, with multiple connection paths to multiple other facilities, each of which also having multiple paths connection them to other facilities. Two facilities are deemed connected by a connection path, as used herein, if food items are sent directly from one to another.

Facility 106 is a distribution facility—a facility that receives food items processed elsewhere, stores them for an indeterminate amount of time, and then releases them to be distributed to other facilities. It's presence in FIG. 1 indicates that some of the facilities that are a part of the food processing and distribution network linked to central facility 100 can merely save such items and distribute them to other facilities. In short, not all facilities are required or even expected to change the nature of the food products passing therethrough.

Facility 108 represents a third type of entity that can receive and contain food items. Facility 108 represents vehicles generally, such as trucks, boats, cars, rail cars, barges and ships that transport food items from one processing facility to another. Vehicles 108 can carry food items in many different containers, including nested containers. For example, an individual food item such as a package of ground beef, can be carried in another food item such as a box, which in turn can be carried in another food item, such as a pallet of boxes, which can be carried in another food item such as a shipping container, which can be carried inside a vehicle itself.

Each of the facilities 100, 102, 104, 106 and 108 include a computer configured by internal programmed instructions as a relational database system (RDS) that receives data from a variety of input devices such as keyboards, pointing devices, bar code readers, RFID readers and writers. The data entered into the RDS indicate the status and identity of food items at or in the facility, including such values as a date stamp, a time stamp, a unique tag identifier, such as a barcode or RFID number associated with the food item, the facility at which the record was made, the location where the record was made (e.g. latitude/longitude), the location in the process (e.g. the station or room) at which the record was made, food item temperature, and facility temperature.

The data input at each of the remote facilities 102, 104, 106, and 108 is transmitted over communications links 110, 112, 114, and 116 to central facility 100, which also has a computer system configured as an RDS that receives this data from each facility, stores it and processes it in a manner described below. For optimum communication of food item data, the items of data are broken down into small packets of binary data, preferably having a size of 256 bytes or greater. Since much of the data coming from each of the remote facilities is the same, each remote facility also provides with in each packet a special locator number, preferably a value made of several individual binary digits that identifies the remote facility to the central computer system. These binary digits preferably do not identify the facility itself, but identify the computer or computers that are at the remote facility and in communication with the computers at the central facility. Thus, each packet transmitted over links 110, 112, 114, and 116 includes a multi binary digit address identifying the computer at the remote facility to which it is sent and one or more values of binary digits that indicate food item identification or food item status.

The RDS at the central facility 100 receives this data from each of the remote facilities, automatically correlates it, and from that correlation determines the location and status of any food item in the processing and distribution network at any time.

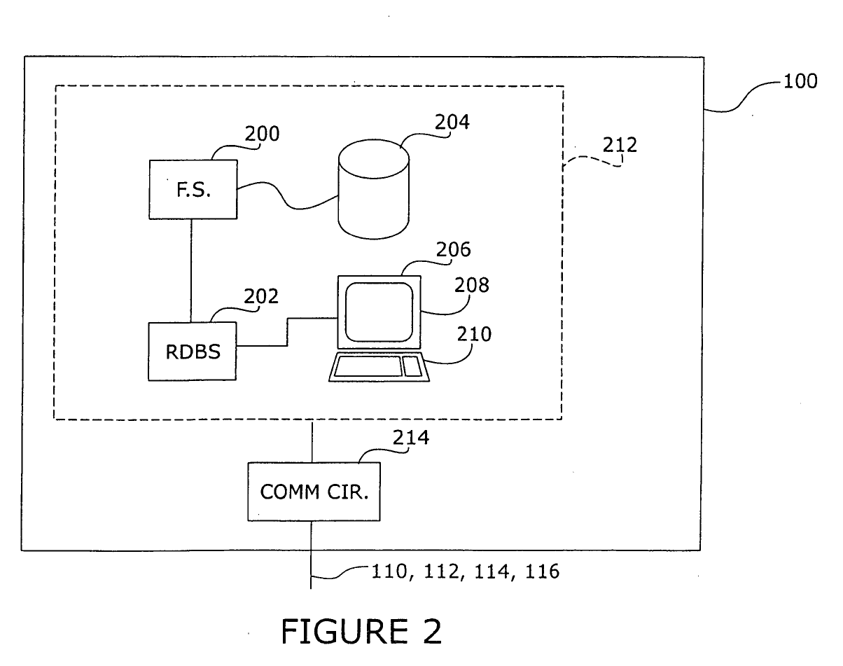

FIG. 2 illustrates central processing facility 100 and its computer system 212. System 212 is coupled to and receives the data from the communications links 110, 112, 114, and 116 extending between central facility 100 and remote facilities 102, 104, 106, and 108. Communication circuit 214 is coupled to and between computer system 212 and the telecommunications links 102, 104, 106, and 108 to buffer and manage this communications.

### Drawing Needs Correction (102 ->200)

System 212 includes a first computer 200 configured as a file server, that is coupled to a second computer 202 configured as a database engine and to a mass storage device 204 which stores the data received from each of the remote facilities over their respective communications links. A user interface 206 is coupled to second computer 202 and includes a graphical display 208 and a keyboard 210.

Fist and second computers 200 and 202 are preferably general purpose computers running a UNIX or Microsoft operating system, such as Linux, BSD Unix, Solaris, or Microsoft Windows (preferably in one of its server versions).

Computer 202 is preferably programmed to function as a relational database system, using general purpose database management software, such as Ingres, Oracle, DB2, or Microsoft Sequel Server that is configured to provide the capabilities described herein.

A significant amount of data is received from each of the remote facilities. The system is therefore configured to offload the tasks of managing the data files and data structures such as tables and indices that computer 202 uses (described below) to computer 200. To provide this support, computer 200 is configured to function primarily as a file server to serve data to the RDS of computer 202.

The data, which is served up by computer 200, is stored in mass storage devices 204. These devices are preferably high capacity disk drives that are configured as one or more RAID arrays to provide the preferred redundancy and speed of access. They may also be large arrays of volatile or non-volatile solid state memory circuits, compact disks or other high speed data storage and retrieval devices yet to be developed.

In the preferred embodiment central facility 100 is a dedicated computing facility that has no associated food processing or distributing functions. Hence, we have not illustrated any associated scanners, bar code readers, RFID readers or other such devices associated with the computer system 212 to provide immediate local automated entry of food item identification and status data, such as that transmitted over communications links 110, 112, 114, and 116. The central facility may, of course, be located at processing or distribution facility, in which case the facility would also have computers with data gathering and transmitting capabilities such as those associated with the remote processing and distribution facilities.

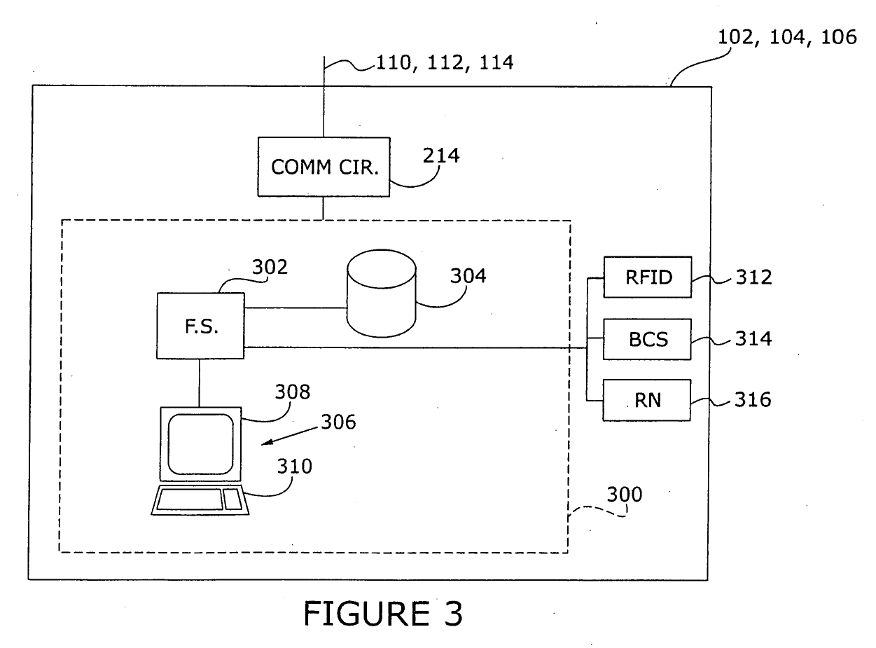

FIG. 3 illustrates a computer system 300 at any of processing facilities 102, 104 and distribution facility 106. The system 300 includes a first computer 302 that is configured as a relational database system (RDS). A mass storage device 304 is coupled to computer 302 to store and retrieve food item identification and status data. This device 304 preferably includes one or more disk drives in a RAID array, a volatile or non-volatile solid state memory device or other fast mass storage device yet to be developed.

Computer 302 is preferably a general purpose computer configured to run a UNIX or Microsoft operating system. Linux, BSD UNIX, Solaris, or a Microsoft Windows operating system tailored for server use are preferred.

To provide its relational database capabilities, computer 302 preferably runs a commercial database system such as Ingres, Oracle, DB2, or Microsoft Sequel (SQL) Server. These programs can be configured to provide the functionality we describe herein.

A user interface 306 is coupled to computer 302 to permit an operator to control the computer system 300 and to enter other food item identification and status data that cannot be entered automatically by such things as bar code scanners, RFID device readers, blue tooth receiver/transmitters, and other radio communication s network devices such as 802.11 network cards. The user interface 306 preferably includes a graphical display screen 308 for displaying data generated by computer 302 from that data, such as the location, quality and status of food items in the remote facility. Interface 306 also includes a keyboard for entering data.

Several data entry and programming devices are coupled to computer system 300 and computer 302 to receive data regarding food items in the facility and transmit them to computer 302 for storage. These devices include radio frequency identification device (RFID) scanners and programmers 312, bar code scanners 314, and radio-networking devices 316 such as transceivers configured to communicate with Bluetooth and 802.11 equipped processing equipment or process monitors. There are preferably many of each of devices 312, 314, and 316 arrayed throughout the work areas of facilities 102, 104 and 106 to automatically gather information regarding the food items and their status as the items pass through the work areas for processing or storage. Details of some preferred arrangements of these devices are provided below.

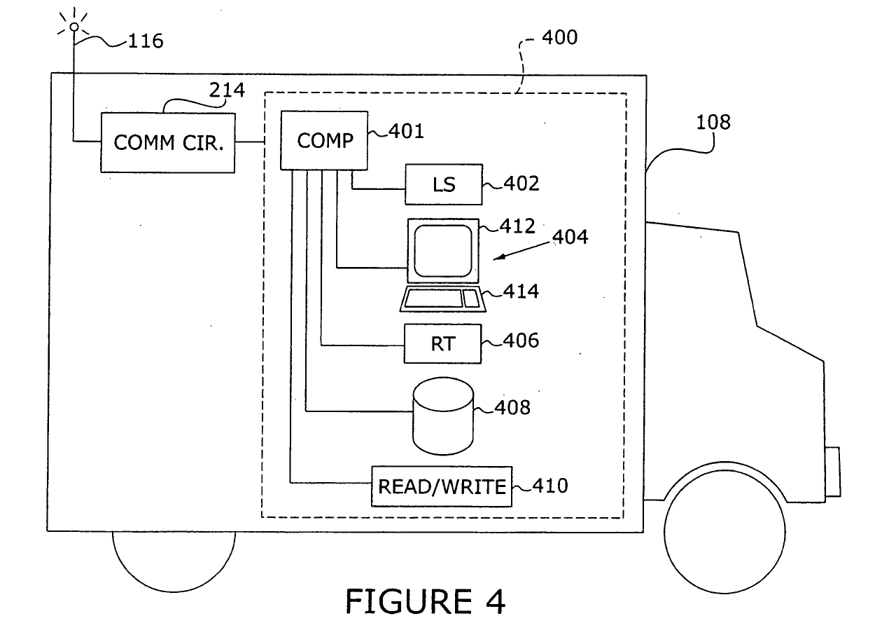

FIG. 4 illustrates a vehicle 108 having a computer system 400 that is connected by link 116 to central facility 100 and its computer system. Vehicle 108 itself may be a wheeled, airborne or waterborne vehicle. It is preferably a boat, a barge, a ship, a plane, a truck or a rail car. Vehicle 108 itself generally performs no special processing (with the exception, perhaps, of a fishing vessel that has an integrated fish factory). Since its primary function is to carry packaged food items from one stationary facility to another, and to maintain the food items in a sanitary condition, the computer system 400 that is mounted on vehicle 108 has special characteristics.

Vehicle 108 includes computer system 400 having a computer 401 that is coupled to a location sensor 402, a user interface 404, a radio transceiver, RFID tag reader and/or bar code scanner 406, mass storage devices 408 and a compact memory circuit reader/writer 410. User interface 404 includes a graphical display 412 and a keyboard 414.

Computer 401 is preferably a general-purpose computer configured to run a UNIX or Microsoft operating system. Linux, BSD UNIX, Solaris, or a Microsoft Windows operating system configured for file serving and relational database use are preferred. Alternatively, and depending on the environment, computer 401 may be configured as a disk-less workstation with enough non-volatile ram to store the data generated by the input devices over the life of the transportation and.

To provide its relational database capabilities, computer 401 preferably runs a commercial database system such as Ingres, Oracle, DB2, or Microsoft Sequel (SQL) Server. These programs can be configured to provide the functionality we describe herein.

Location sensor 402 may be any of a variety of devices configured to determine the position (relative or absolute of vehicle 108. It may be radio receiver configured to receive satellite or terrestrial radio signals (or both) and responsively generate an electronic digital signal indicative of the vehicle's position. Such device may include a GPS receiver, a cellular telephone circuit including a GPS integrated circuit, a dead reckoning circuit such as one configured to receive signals from a bearing indicating sensor (e.g. an electronic compass and a velocity sensor, and to generate a signal indicative of vehicle 108 position therefrom.

User interface 404 is coupled to computer 401 to permit an operator to control the computer system 400 and to enter such food item identification and status data that has not been automatically entered by the computer system at the facility or by devices 406 and 410. The data entered into the vehicle's computer system 400 by electronic memory transported from the facility to vehicle 108 and coupled to reader writer circuit 410, or by telecommunications to the vehicle using radio transceiver 406 preferably includes such data as the location, quality and status of food items in the remote facility that are to be transferred to another facility via vehicle 108 as well as the destination the vehicle is to travel, its route, the departure time, the arrival time for the complete journey as well as arrival times and travel times to any intermediate destinations.

Data from the stationary facilities 102, 104 and 106 from which the vehicle 108 transports goods can be transmitted directly from those facilities to the computer system 400 of vehicle 108 using the vehicle's transceiver 406 or the reader/writer circuit 410. Alternatively, the operator of the vehicle 108 can electronic media, such as electronic memory cards, portable disk drives and the like that are connected to User interface 404 preferably includes a graphical display screen 410 for displaying data generated by computer 401 from that data, such as the location, quality and status of food items in the remote facility. Interface 404 also includes a keyboard 412 for entering data.

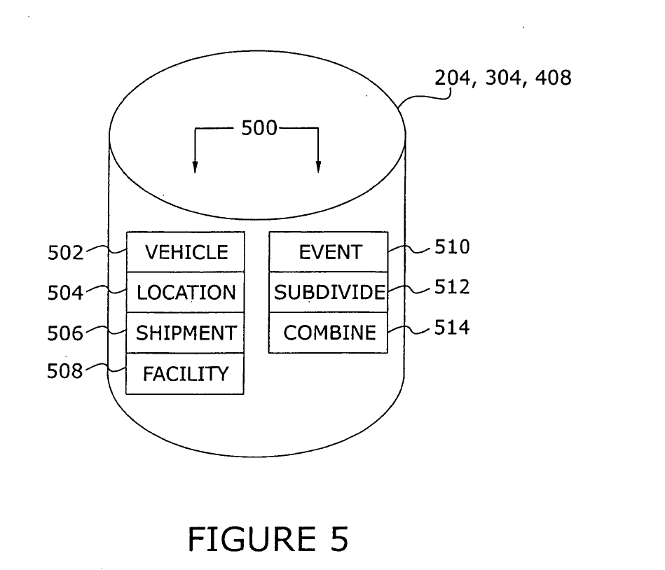

FIG. 5 illustrates mass storage devices 204, 304, and 408 of computers 212, 300, and 400 respectively. The mass storage device includes several data structures 500 that hold data indicative of the food item's identity and status. Each of computers 212, 300, and 400 are configured as a relational database system. They are configured to access data structures 500 to determine the identity and status of the data items in a programmed manner that will be described below.

Data structures 500 include several tables that contain the food item data and other related data as well as various indexes used by computer 202 to quickly sort the data in the tables.

The first table is Vehicle Table 502. The fields of the Vehicle Table include digital values indicative of vehicle 108, its journey and its location. Each record of the Vehicle Table has the following fields: (a) a vehicle identification number (“vehicleID”) of the vehicle in transit, (b) the origin of its journey (“journeyOrigin”), (c) the destination of its journey (“journeyDest”), (d) the vehicle's departure time and date(“timeDepart”), (e) the vehicle's arrival time and date (“timeArr”).

The second table is the Location Table 504, which indicates the location of each vehicle 108 and the time that that vehicle was at that location. Each record of the Location Table has the following fields: (a) the vehicle ID (“vehicleID”), (b) the vehicle location (“location”), and (c) the time the vehicle was at that location (“locTime”). This table is populated with data transmitted from each vehicle 108 as it travels from location to location.

The third table maintained in the mass storage devices is Shipment Table 506. The Shipment Table has a record of each food item carried by the vehicle 108. Each record of the table includes the following fields: (a) the ID of a vehicle carrying the shipment (“vehicleID”), and (b) the ID of a food item carried by the vehicle (“foodItemID”). Since most vehicles carry numerous food items there are many records for each vehicle shipment.

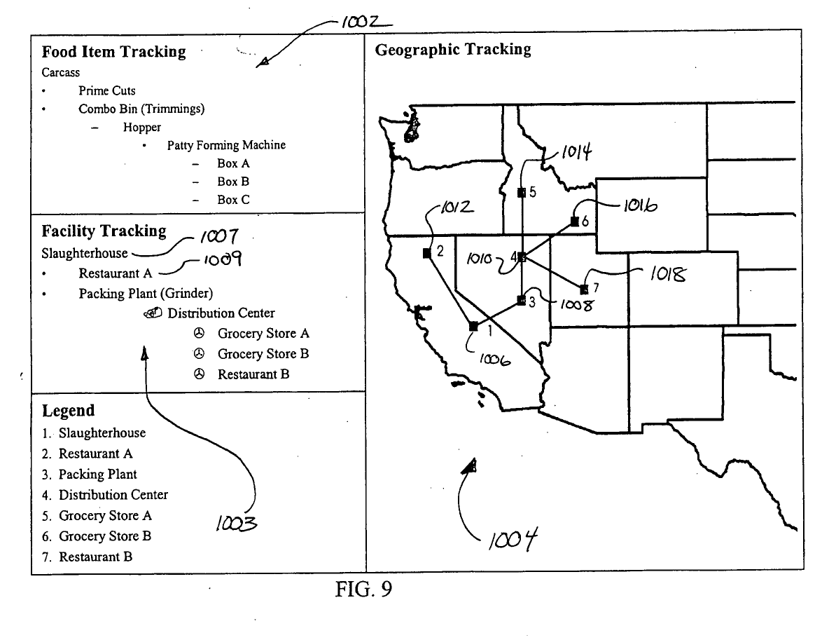

A fourth table, the Facility Table 508, stores data indicative of each facility in he processing and distribution network. Each facility in the network has its own table entry. The fields in the table include: (a) the facility identification number (“facilityID”), (b) the facility's name (“facName”), (c) the facility's address (“facAddress”), (d) the contact at the facility (“facContact”), (e) the telephone number of the contact (“facConTel”), and (f) the physical location of the facility (“facLoc”). With this information, computers in the system can display various maps of the network showing the location of the various facilities in a particular network as well as information such as their names and the local contact person and contact information on screen when identifying sources of contamination and tracking down the facilities responsible (see FIGS. 9, 10, and 11). With this information, an operator can contact a facility identified as having or producing contaminated food items and have the facility cleaned, and any questionable food items embargoed or destroyed. If the contaminated facility is a vehicle, the operator can contact the vehicle in transit and direct it to a particular inspection facility or depot.

The tables described above serve to identify food items in shipment and also permit the system operator to locate individual facilities. A significant capability of the system, however, is its ability to track food items from facility to facility, and to monitor and make a database record of any significant events in the life of the food item. This data can be used to track contaminated food back to its source. If the ranch at which the cattle is initially raised is configured with a computer system such as facility 102 or 104, and if each subsequent location, such as feedlots, slaughterhouses, processing plants, distribution centers, groceries, and restaurants are also so configured, it will be possible to trace any food items all the way back to its source ranch or farm.

Additional information is necessary, however, to backtrack or forward-track from a point of contamination to identify other food items that may be contaminated, and that is found in the Event Table. This information is found in the Event Table 510. The Event Table lists the various events in the life of a food item, when they occurred, where they occurred, and data indicative of the result of the event, if appropriate. Each of these categories corresponds to a field in the Event Table, which include: (a) the ID of he food item experiencing the event (“foodItemID”), (b) the event in question (“eventID”), (c) the time and date of occurrence (“eventTime”), (d) the location at which the event occurred (“locationID”), (e) facility ID of the facility where the event occurred (“facilityID”), and (f) the result of the event (“resultID”), if any.

“Arrival” is the first event. When a food item, whether a complete living animal or a part of that animal, arrives at a facility, it is logged into the computer system of the facility with an event entry indicating the food item ID, the facility ID where it arrives, and the date and time it arrived, and an eventID value indicating that the event was an arrival.

The computer system for that facility is preferably configured to make the “arrival” entry into the Event Table automatically by way of automated scanners such as RFID scanners, bar code scanners or the like (assuming the food item has an attached bar code tag or RFID tag) disposed at a predetermined entry point, such as a animal chute or gate of a corral or pen at a farm, ranch, feedlot or slaughterhouse, a loading dock at any type facility, a warehouse doorway inside a facility, or (for larger facilities) a transition point defining different areas within the facility, such as a slaughter area, a cooler area, a loading dock area at a large slaughterhouse, a boning room, individual boning stations within the boning room, and the killing floor.

By providing additional arrival and departure points within a facility and not merely at the entrance to the entire facility, the computer system of that facility can maintain a record not merely of each the food item that has arrived at the facility, but exactly where it is within the facility. Other locations within a facility where a food item may be recorded in the computer system as having arrived or departed include a grinding machine, a vehicle, a hamburger patty forming machine, a combo bin, a loading dock, a trimming station in a boning room of a slaughter facility, a boxing station, and a shipping/receiving department.

While the recording of a food item's arrival is preferably automatic using devices 312, 314 and 316, it may be manually entered into the facility's computer system by manual operator entry using the keyboard 310 of the user interface associated with that computer system. Other radio frequency, audio frequency, or visual frequency scanners may be coupled to the computer 300 to automatically receive identification date from the food item.

When a food item leaves a remote satellite facility, computer 300 is configured to log a “departure” event—to enter a record into the Event Table identifying that event as having occurred. As with the arrival events, this logging can be done automatically by sensors that respond to identification tags associated with the food items or food item containers. As with the arrival events, scanners or other automatic data input devices 312, 314, and 316 can be located at other locations within the facility to provide more detail about the food item's whereabouts within the facility. The sensing devices 312, 314, and 316 are configured to receive signals indicative of the food item ID and the computer is configured to receive those signals and make a record in the Event Table. It should be noted that there may be many more sensing devices 312, 314, and 316 to populate all the areas of the remote facilities that need monitoring, including one or more sensing devices for each location noted above as a station in the boning room.

A third kind of event is the “subdivide” event. It is represented in the Event Table by an event record having an eventID value that is different from the eventID values for either the arrival event or the departure event. A subdivide event occurs when a food item is split or otherwise subdivided into two or more portions of the original food item. For example, when a cow is butchered, the entrails go in one direction and the flesh goes in another direction, a subdivide event occurs. When a carcass is split, prime cuts are removed and the remainder goes to a grinder to make ground beef, this too is a subdivide event. When a 2000 pound hopper of beef is turned into 20,000 individual beef patties this too is a subdivide event. It should be clear that these are just a couple of the many different ways a food item may be subdivided.

There is an alternative way of recording the subdivision of a food item that is described below, in which two food item IDs are not associated directly as an entry in the subdivided table, but are associated indirectly using computer logic to establish the relationship later. For example, in one embodiment, when a carcass is trimmed at a trimming station by cutting some scrap and placing it into a combo bin, there are two records made that establish this relationship between the combo bin that receives carcass scraps and the carcass (or carcasses) from which the scraps are removed. When the carcass moves to the station, an arrival event is recorded in the Event Table indicating that the carcass arrived at that station. Similarly, when a combo bin arrives at that self-same station to receive carcass scraps, its arrival is also recorded in the event table as an arrival at that station.

By searching the arrival events, the remote satellite computer or the central computer are both configured to examine the Event Table and determine which carcasses and which combo bins were present at the same stations at the same time. If they were present at the same station at the same time, and the station is one at which the carcass is trimmed, cut or otherwise subdivided, the computer knows and is configured to determine that the combo bin in question received some portion of the carcass—in short that a subdivided event occurred.

Whenever a food item is subdivided into two or more other food items (i.e. a subdivide event occurs), computer 300 is configured to electronically record a subdivide event in the Event Table and to make several additional electronic records in a corresponding Subdivide Table 512. The Subdivide Table 512 includes records that associate a food item with the food items into which that food item is subdivided. Each record in the Subdivide Table includes a field identifying the original food item (“foodItemID”) and relating it to a food item of one of the food items into which it has been subdivided (“foodItemID”). Thus, if a carcass is subdivided by quartering, there will be four corresponding entries in the Subdivide Table. The first of these records will indicate the carcass food item ID followed by the upper left quarter food item ID. The second will be the carcass ID followed by the upper right ID. The third will be the carcass ID followed by the lower left ID, and the fourth and last will be the carcass Id followed by the lower right ID.

The subdivide event is recorded as a record in the Event Table that includes (a) the ID of the food item being subdivided (“foodItemID”), (b) a value indicative of the subdivide event (“eventID”), (c) the time and date of the subdivision (“eventTime”), (d) the location at which the subdivision occurred (“locationID”), (e) the facility ID of the facility where the subdivision occurred (“facilityID”). There is no “resultID for a subdivided event.

When a food item is created by subdivision, a new food item ID is created for those subdivided parts arbitrarily by the computer system 300 at the processing facility that does the subdividing. Since this number is preferably unique to the food item, each facility may be provided with their own list of numbers or methods of generating numbers that guarantee their uniqueness. Alternatively, each facility can independently assign food item ID numbers, and the central computer 212 can attach a separate number identifying the facility at which those numbers were generated to maintain uniqueness. There are other well known techniques for insuring the uniqueness (or near-uniqueness) of numbers generated at different sites and different times.

The next type of event is the “combine” event. A combine event is recorded in the Event Table whenever two or more food items are joined together and it is desirable to track the joined food items through the system by a single number. As examples, a combine event could occur when two combo bins of meat (two initial food items) are mixed together in a grinder to form a hopper of mixed meat (the single resulting combined food item), or when sixty-four boxes of beef are stacked together on a shipping pallet, or when several shipping pallets are loaded into a single shipping container. The important factor is that when two or more food items are joined together and given another food item ID for the combination, they can be later separated by the computer searching the data in the Event Table 510 and Combine Table 514. Since computer 300 is configured to make a record of every food item ID change in the tables, the computer can always backtrack or forward track through a combine event.

Entries in the Event Table 510 for a combine event are the same as the entries for a subdivide event with one exception: the eventID for a combine event is different from the eventID for a subdivide event.

Whenever a combination occurs, the computer system at the facility where it occurs makes several associated entries in the Combine Table 514. The Combine Table is similar to the Subdivide Table. Instead of associating a single original food item with “N” multiple subdivided food items, where “N” is the number of subdivided items (and the number of records in the Subdivide Table), however, the Combine Table associates “N” original food items with the single combined food item into which they are combined. Instead of one-to-many, the associations in the Combine Table 514 are many-to-one.

Another event stored in the event table is a change of ownership event. When a food item is purchased, regardless of is location or state, the computer system 300 at the facility 102, 104, and 106 is configured to enter a change of ownership into the Event Table. A change of ownership record storing that event includes (a) the ID of the food item experiencing the change in ownership (“foodItemID”), (b) a number indicating that this record is a change in ownership record (“eventID”), (c) the time and date of the change in ownership (“eventTime”), (d) the location at which the change in ownership occurred (“locationID”), (e) facility ID of the facility where the change in ownership occurred (“facilityID”), and (f) the result of the change in ownership—in this case, a numeric value identifying the new owner (“resultID”). This data is typically entered manually into the system by an operator at the user interface of the computer system. In this manner, when the central computer system sorts through the records to determine which food items are contaminated and which are not, it can select or sort food items based upon the current (or past) owners of the items. This may be useful in tracking down individual sources of contamination as well as in reporting contamination to the authorities.

Another event that is entered into the Event Table is a test event. A test event can be described generally as a result of any test performed on the food item. If it's weighed, that is a test. If its fat content is determined, that is a test. If its color, density, volume, temperature, size, shape, configuration, speed, fluidity, liquidity, solidity, plasticity or any other physical characteristic is determined, that is a test and a testing event has occurred. Most importantly for the present application, are tests that indicate contamination, infection, adulteration or disease (collectively called “contamination” herein). Typical tests performed on food items include the following: Salmonella, generic E.coli, and Listeria.

Many of these tests are not binary. A binary test as we use the term here, means a test that has a binary result: yes/no, good/bad, contaminated/not-contaminated. Many tests provide results that can be expressed as three or more values in a range of values. For example, the number of contaminated cells found in a food item sample, or the size of a contaminated region cultured from a food item sample. These can be expressed as a range of values qualitatively, such as small/medium/large, or quantitatively, such as 1/100/1000 or 1/2/3. They can even be expressed as a range of ranges such as 1-50/51-100/101-500. These ranges of values are important because the central computer 202 uses the ranges as a contamination search filter, which will be described below.

The computer system in the test facility is configured to enter a test event in the Event Table as a test event record having the following fields: (a) the ID of the food item tested (“foodItemID”), (b) a number indicating that this record is a test event (“eventID”), (c) the time and date of the testing (“eventTime”), (d) the location at which the testing occurred (“locationID”), (e) facility ID of the facility where the testing occurred (“facilityID”), and (f) the result of the testing—in this case, a numeric value identifying one of the two possible test results (if a binary test) or the three or more possible test results (“resultID”). In this example, the eventID is different for each type of test executed. In other words, each different test has its own corresponding eventID. As new tests are created, each is assigned its own unique test ID by the central computer system.

The tables described above include all the data required by the system overall to perform the functions described below. In this embodiment, the computer system at each facility 102, 104, 106, and 108 receives the data and stores it in its own associated mass storage devices. The computer system at each facility 102, 104, 106, and 108 also transmits the data in each table over links 110, 112, 114, and 116 (respectively) to the computer system at the central facility 100. The computer system at the central facility 100 receives this data over the link and stores it for use in its own mass storage devices.

In an alternative configuration, facilities 102, 104, 106 and 108 do not save a copy of the table data they gather in a local relational database, but transmit it directly to the central computer system in central facility 100 for storage and processing, such as by entering the data into an HTML document having user-fillable fields that are posted to a web server at the central facility 100 over the telecommunication link extending between that remote satellite facility and the central facility. In this manner, the owner or operator of a facility may be able to avoid some or all of the cost of maintaining a computer system with a complex RDS in-house.

Furthermore, a third alternative is to provide a mixed system in which some of the data gathered at the satellite facilities are sent directly to the central computer and some are gathered and maintained in tables or other data structures at the satellite facilities 102, 104, 106, and 108 to be later transmitted from the satellite facilities to the central facility on command of an operator at the satellite facility or an operator at the central facility, or on a predetermined automatic schedule.

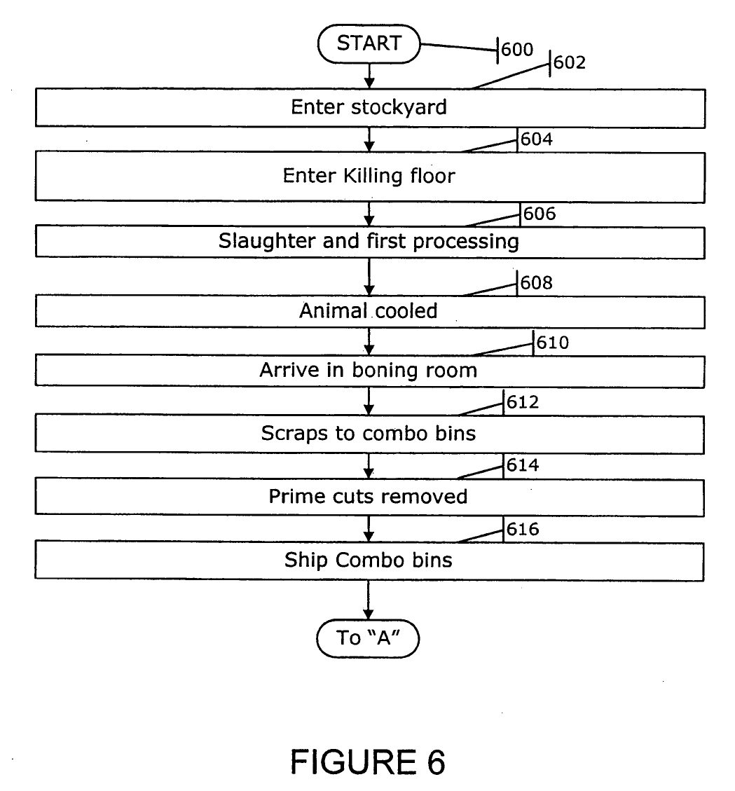

FIG. 6 illustrates in more detail how the various data are gathered and entered into to facilities' computer systems as a food item passes to each and through both. In FIG. 6A, the process starts at block 600 when a beeve enters the system.

In block 602, the beeve is brought into the stockyard of a slaughterhouse, typically through a predetermined gateway. The beeve typically arrives in a truck or railcar. In a preferred embodiment, the beeve has a scannable tag or label such as a bar code or an RFID tag inserted under its skin or hanging from an ear. A scanning device, such as one of the RFID or bar code scanners attached to computer 300, senses the presence of the scannable ID and transmits this data to computer system 300. The computer system is configured to receive this data from the scanner located at the predetermined location and make a record in the Event Table that a beeve has arrives in the stockyard and one that the beeve has arrived in the facility.

Eventually, the beeve will be taken from the stockyard to the killing floor of the slaughterhouse to be killed as shown in block 604. The beeve is lead through another gateway to the killing floor where it is stunned and killed. When it passes through the gateway to the killing floor, another scanner coupled to computer system 300 transmits a message to computer 300 that the beeve's ID tag has been read. Computer 300 is programmed to interpret this as meaning the beeve has left the stockyard and has entered the killing floor. Hence, computer 300, in response to receipt of this signal, makes a departure record in the Event Table indicating that the beeve has departed the stockyard and enters a record in the Event Table an arrival record indicating that the beeve has entered the killing floor area. Thus the computer system at the facility has a record of the location of the beeve within the facility itself.

As indicated by step 606, the beeve is killed and some initial processing is performed. This processing preferably includes placing a back tag on the hide for carcass identification, de-gutting, de-hiding, carcass cleanup, FDA inspection, sending head and separable organs to biologist for inspection, getting the OK from the biologist, (and routing the carcass off the conveyor track if the carcass is not cleared by the biologist) dissection, removing sellable organs, shooting a plastic ID into the ribs, a hi-temperature bath and chemical treatment.

In this step there are several subdividing events that are recorded in the computer system at the facility. The carcass with its scannable tag (usually on the ear) is separated into several different portions, including organs and head, hide, and clean carcass. RFID tags or labels are applied to the organs (or organ container), the hide (or hide container) and the carcass. The numbers on or in these three tags or labels are scanned into the computer system by another scanner and are associated with the animal's original food item ID number to make three additional entries in the Subdivide Table. Thus, one can enter the Subdivide Table with the hide, the organ or the carcass IDS and get the ID of the animal from whence they came. Of course, the same data can be entered manually.

The clean carcass may not need a separate ID number. Instead, the computer may make a record of what hook the carcass is hung from if there is some unique method of identifying each hook as its is drawn through the factory. Some conveyor systems provide unique tracking of conveyor hooks throughout a factory. In such a system, the computer system need not apply a separate tag to the clean carcass, but merely note, by scanning the hook (fit has some associated scannable structure such as a bar code tag or an RFID tag) or by querying the conveyor system for the ID of the hook on which the carcass is being hung, and making a record of that hook number plus the animal's original food item ID number. This would make records in the subdivided table indicating that the animal has been subdivided into the hide, the organs, and the carcass hanging from hook number XXXX, where “XXXX” is the number of the hook on which the carcass is hung.

The FDA or an in-house biologist, or both, will test the carcass, the organs, or the hide. Since each portion has its own new food item ID number, the test results are entered into the event table as a test record. The individual tests are described above.

Once the animal has been subdivided, the clean carcass is carried by the conveyor into a cooler where it is kept for 24-36 hours to cool before additional processing. This is shown in step 608.

In step 610, the clean carcass is taken to the boning room, wherein it is separated into several parts, including several prime cuts hat are typically placed in several boxes, according to the type of the cut, and several scraps that are placed in one or more “combo bins” as described below.

In a large facility, the carcass is hanging on a conveyor that moves continuously through the facility, moving all of the carcasses simultaneously. When the carcass has been cooled for a predetermined period of time, it is conveyed into the boning room. As the carcass enters the boning room its identification device is queried to identify the carcass. This querying may be done by scanning the carcass with a scanner, either RFID or bar code, or by the conveyor system identifying to the computer system in the facility which hook is now entering the boning room. In short, either the carcass itself or the device conveying the carcass has a value that indicates the unique food item ID of the carcass. In this manner, the carcass is identified to the machines and personnel in the boning room that subdivided the carcass.

Once in the boning room, the carcass is first trimmed by removing scrap portions of the carcass (block 612) when the scrap portions of the carcass are removed, the remaining trimmed carcass is segmented into prime cuts of beef (block 614).

In the simplest process, the scraps from each of several carcasses are removed and placed in a single combo bin. A “combo bin” is a large open wheeled container. Once a combo bin is filled, it is commonly sent to a meat grinding facility to be turned into ground meat. The step of combining multiple carcass scraps into a single combo bin is shown as step 612 in FIG. 6. Each combo bin weighs approximately 2500 pounds and contains the scrap meat from 12-25 beeves. As the scraps are loaded into each combo bin, a scanner scans the tag and transmits it to the computer. The computer, in turn, records a subdivide event in the Event Table and two records in the Subdivide Table: a first record associating the combo bin ID with the carcass food item ID and the second record associating the trimmed carcass food item ID with the carcass food item ID. Each combo bin preferably has an RFID or other scannable tag that is read by a scanner coupled to the computer system. This number or a number correlated with this number is the combo bin food item ID.

There is preferably a single scanner (such as the bar code or RFID scanners connected to computer 300) that detects both the carcass and the combo bins at each station. This scanner is preferably located at the station near both the carcass to be trimmed and the combo bin itself. In this manner, as each carcass is brought within range of the scanner, the scanner will sense both the scannable tag or label on the carcass or conveyor hook, and on the combo bin, and generate a signal indicative of both the combo bin and the scrap carcass, subsequently making the appropriate entry in the Combine Table that associates the combo bin's food item ID number and each successive carcasses' food item ID number.

In this manner, the computer system in the facility has identified the carcasses with the combo bin that receives them, and which has their new combined food item ID number. Since the carcasses to be trimmed have been combined, and a computer entry created that indicates this combination, any contamination that appears in the products located downstream of the combo bin can be backtracked to all the animals that contributed to the scraps in that combo bin.

In a similar fashion, the carcass is cut into several prime cuts that are individually packaged for shipping. When each cut is removed, it may be individually wrapped, or it may be placed in a box with other cuts. To maintain the identity of the meat and permit backtracking and forward tracking, either each individual cut or each box of cuts may be identified by a new food item ID that is linked to the carcass food item ID by a new subdivide entry in the Event Table and two or more (depending upon the number of subdivisions) record entries into the subdivide table associating the trimmed carcass with the individual cuts.

A printer may be provided to print out labels with the new food item ID's for each individual cut or box of cuts. Alternatively, the boxes may be pre-labeled and the labels manually or automatically scanned into the facility's computer system. Alternatively, RFID tags may be attached to the individual cuts or to the boxes of cuts and scanned into the facility's computer system. The computer system can then make the necessary entries into the subdivide table to link the trimmed carcass with the cuts.

On occasion, a box of prime cuts may be filled with cuts from several different successive carcasses, and not just a single carcass. In a case like this, the computer system is configured to store a record indicating that a “combine” event has occurred. The computer system of the facility records a combine event in the Event Table, and correspondingly records the individual food item ID of each carcass contributing prime cuts to the common box together with box's food item ID. Thus, for example, if prime cuts of three carcasses were put into the same box, a single combine event would be recorded in the Event Table, and three entries would be made in the Combine Table, each entry associating a carcass food item ID number with the box's food item ID number. In this manner, any cut of meat withdrawn from the box could be identified not only with the individual animal from which it came, but also identified with other animals with which it was shipped (in the box) and with which it may have become cross-contaminated.

The above are not the only processes for trimming carcasses and cutting the carcasses into prime cuts, in the boning room, however. In many facilities, rather than a single there are several combo bins, each receiving a different scrap portion successively trimmed from the carcass at each trimming station as the carcass is moved through the boning room by the conveyor. Similarly, there are several cutting stations located along the production line where prime cuts are successively removed from the trimmed carcass as it is carried by the conveyor from cutting station to cutting station.

Thus, at a first station, a first portion of scrap is removed and placed in a combo bin as the carcass is carried past the station. At successive stations additional portions are trimmed off and placed in yet more combo bins. Once the carcass is completely trimmed, it then passes through a series of stations at which it is successively portioned into individual prime cuts. At a first of these stations a portion of the carcass, such as the ribs, is removed and packaged. At a following station, another prime cut is removed and packaged, such as the rump. Other cutting stations follow until there is nothing left of the carcass.

At each of the trimming stations there are two scanners, one scanner disposed to scan the identification label (such as a bar code or an RFID tag) of the carcass or hook as it passes by, and one scanner disposed to read the identification label of each combo bin as it is brought up to that station and positioned to receive scraps.

Whenever a carcass is conveyed to the trimming station, the computer reads the scanner and generates an event for the Event Table, indicating that the carcass has arrived at that station. The record includes and associates the carcass food item Id and the date and time the carcass arrived at that station and a station identifier to permit the computer to distinguish between stations.

When a new combo bin for receiving scraps arrives at one of the several stations receiving scrap portions of each passing carcass, the scanner at that station reads the combo bin identification label and provides its ID to the computer. The computer, in turn, makes another entry in the Event Table indicating that the combo bin has arrived at the station in question. The record includes and associates the combo bin food item Id and the date and time the combo bin arrived at that station and a station identifier to permit the computer to distinguish between stations.

When a new box for receiving the prime cuts arrives at each station where prime cuts are cut from the carcass, the scanner at that station reads the box identification label and provides its ID to the computer. The computer, in turn, makes another entry in the Event Table indicating that the box has arrived at the station in question. The record includes and associates the box food item Id and the date and time the box arrived at that station and a station identifier to permit the computer to distinguish between stations.

Since the computer knows the time period that each combo bin and box was at a station, and since the computer also knows the time period that each carcass remained at that station being trimmed or cut into prime cuts, the computer knows which combo bin and which box received a portion of the carcass. In this manner, the central computer (which receives all this data from the remote satellite computer system) is able to determine which combo bins are associated with which carcasses and which boxes are associated with which carcasses. It is able to link the food item IDs using the time of arrival or departure from the station as the linking index or key.

Once several combo bins have been filled (and their food item ID numbers linked with the animals whose meat fills them), they may be taken to a grinder at the slaughterhouse, or they may be shipped by vehicle 108 to another facility to be processed and packaged as ground beef patties, for example. In the present application we will identify the latter of these two cases—in which the combo bins are sent to another facility in the network.

When the combo bins are filled, they are shipped from the slaughterhouse to another facility that is part of the network including the central facility and several satellite facilities as shown in block 616. When the combo bins are brought to the loading dock, their identification tags are sensed by a scanner coupled to the computer system of the facility and the computer system responsively and automatically records a departure event in the Event Table—an event indicating that the combo bins so identified are leaving the facility or are being placed in a vehicle leaving the facility. Alternatively, the combo bin data may be manually entered at the user interface device coupled to the computer system.

The combo bins are loaded onto the vehicle 108 and their arrival in the vehicle recorded by the vehicle's computer system. If the combo bins have scannable tags or radio networking devices, this can happen automatically by bringing the combo bins within range of the transceiver/reader/scanner 406. Once the combo bin is within range of device 406, the computer system 400 on the vehicle is configured to receive the signals from device 406 and make a record in its internal database that the combo bin has arrived. This process is repeated for each of the combo bins in the vehicle. Alternatively, the computer system at the facility may make a record of the vehicle's load, and transmit it directly to the vehicle via device 406, or by carrying a memory device to the vehicle and installing it in reader/writer 410. In yet another alternative embodiment, the combo bins may be entered into the vehicle's computer 400 manually using the user interface device 404.

While vehicle is underway, computer 400 is configured to periodically receive vehicle position data from position sensor 402 and save data indicative of the vehicle's position derived from the position data in mass storage device 408 in a Location Table. Computer system 400 is configured to communicate the Location Table to mass storage device 204 of central facility 100 computer system 212 over telecommunications link 116 which stores it as Location Table 504. Similarly, vehicle 108 is configured to communicate the records it makes of the food items it carries to computer 212 over link 116 as well. Computer 212 stores this data in Shipment Table 506. Alternatively, the facility from which the vehicle loads and departs (in this case the slaughterhouse) or the facility at which it arrives and unloads (in this case a grinder/packer facility) can transmit this data to the central computer 212.

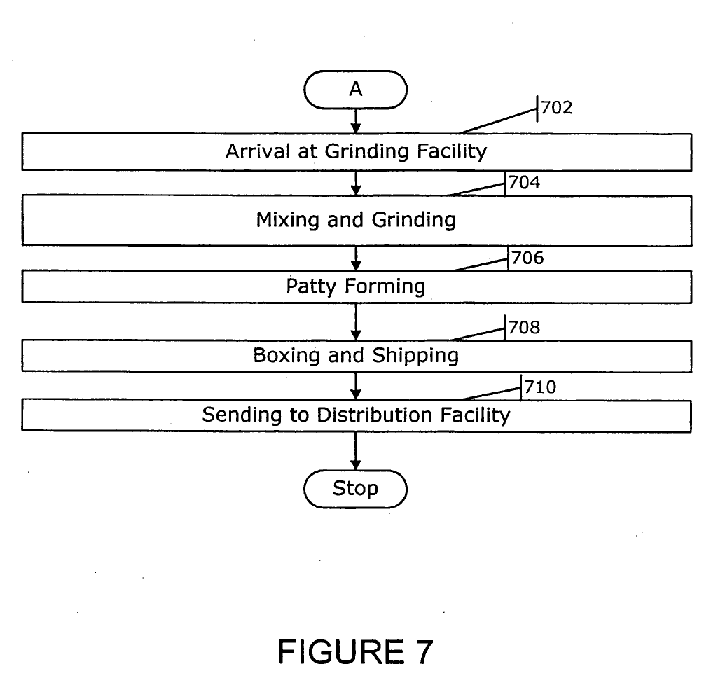

FIG. 7 illustrates the further steps in processing and distributing the beef. The process starts with step 700 in which the beef shipped in combo bins to the grinding facility are ground and processed. And in which the central computer system maintains a record of the various processing steps sufficient to back track and forward track through the system to determine what additional meat is contaminated.

In block 702 the vehicle arrives at the grinding facility, which is a processing facility such as satellite facility 102 or 104 illustrated in FIG. 1. The grinding facility, like the slaughterhouse, has a loading dock or gateway at which the vehicle unloads. This dock is preferably configured with a scanning device to automatically sense the presence of the combo bins when they enter the facility. When it senses the presence of the combo bins, it records that presence in its event table as an arrival event for each combo bin.

As shown in block 704, the combo bins are then mixed and ground together to convert them into a ground meat mixture having the proper composition of fat and lean. The process includes coarsely grinding a first combo bin of scraps (or portion thereof), coarsely grinding a second combo bin (or portion thereof) mixing the two, and finely grinding the coarsely ground portions together in a third, fine grinder to produce a batch of ground beef of the proper fat and lean content.

The grinding of two different combo bins of mean is a change in form and not substance. It is not recorded in the tables of the grinding facility's Event Table. However, when the two different batches of coarsely ground meat are combined in the fine grinder, this process combines two different batches of meat from two different sets of cattle, and is therefore entered into the grinding facility's Event Table as a combine event, combining the two combo bin food items into a single hopper food item. Two corresponding entries are made in the grinding facility's Combine Table. With these entries, meat in the hopper can be traced back to the meat in the two combo bins and meat in the two combo bins can be traced forward to the meat in the hopper.

In block 706, one or more hoppers of meat are inserted into a hamburger patty forming machine, such as a Formax machine, which converts the finely ground meat in the one or more hoppers into meat patties of varying weight—typically 1/10 pound or ¼ pound patties. These patties are ultimately boxed and shipped to one or more distribution centers 106 for further distribution to groceries or restaurants.

When the meat from two or more hoppers are placed in the Formax machine, the grinding facility enters another combine event in the Event Table at the grinding facility indicating this combination and assigns the meat in the Formax machine a new food item ID number. The several thousand patties leaving the machine are not given individual food item ID numbers, but each box that they are stacked in is given a new food item ID number and a subdivide event is recorded in the Event Table by the grinding facility's computer system 300. Each box filled with meat from the Formax machine is assigned a new food item ID number and is associated with the batch of meat in the Formax machine by corresponding entries in the Subdivide Table. Thus, one can trace backwards from a box of meat to the batch of meat in the Formax machine, and forward from the batch of meat in the Formax machine to all the boxes created therefrom.

As shown in block 708, once the meat is placed in boxes, it is then shipped to a distribution facility. The process for shipping the boxes of meat patties to the distribution facility is the same as the process for shipping the combo bins to the grinding facility. A departure event is recorded in the Event Table of the grinding facility for each box leaving the grinding facility. A corresponding entry is made in the computer system of vehicle 108 carrying the boxes to the distribution facility. These entries may be automatic or manual, just as described above regarding the transfer to the grinding facility. The vehicle 108 functions as described above in receiving data regarding the shipment, recording its location and transmitting the shipment and location data to the central computer either automatically or manually. It makes the same records, communicates the same information, gathers the same data and transfers food items in the same manner.

In block 710, the distribution facility 710 receives the boxes of meat patties in the same manner, records data in the same manner and communicates data with the central computer 212 and the vehicle 108 as does the grinding facility upon receiving the shipment of combo bins from the slaughterhouse.

Thus, from FIGS. 6 and 7 it can be seen that the computer systems at each facility, the slaughterhouse, the grinding facility and the distribution facility, all track the identity of food items as they are processed, packaged, shipped and transformed. They record in electronic form records indicating each transformation. These records relate the food items before transformation (either combining or subdividing) to the food items after transformation. The computer systems at each facility make electronic records of test results performed at that facility, and relate the recorded test results to each food item that is tested.

It can also be seen from FIGS. 6 and 7 that this recorded electronic data is transferred to a central computer facility that can relate the data transmitted to it from each of the facilities and the vehicles transporting goods between the facilities sufficient to establish the present location of all the food items in the processing and distribution network, to determine all the test results of tests performed on food items in the distribution network, to trace forward and backward through the processing and distribution network to identify any food items from which the food item in question is derived, and to establish all food items that are derived or descended from the food item is question.

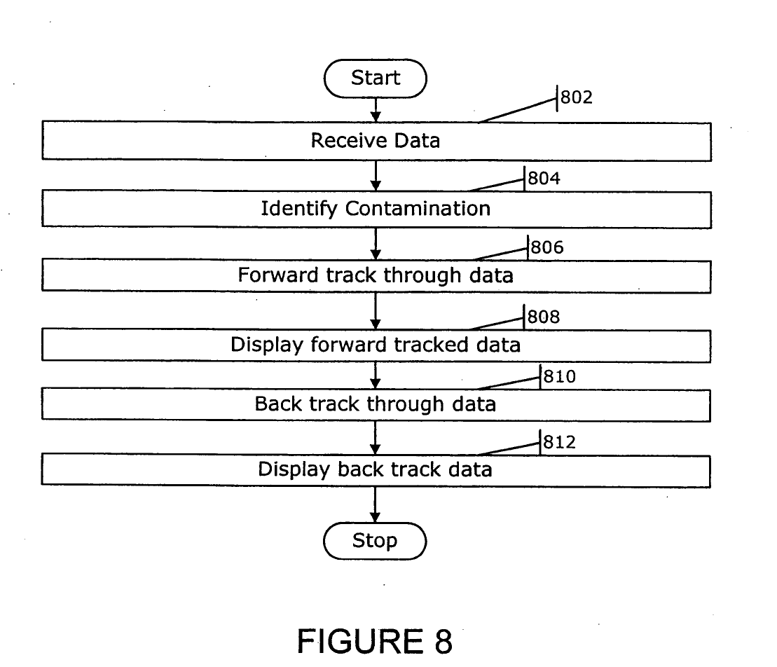

FIG. 8 illustrates the functions performed by the central computer system on all the data that it has received from the remote facilities identified herein. While only four such facilities of which one is a vehicle, are shown in FIG. 1, the current system may include fewer than this number of remote satellite facilities, or (preferably) many, many more, all feeding their data to the central facility for processing and correlation.

In block 802 central computer 212 receives the data from each of the remote satellite facilities 102, 104, 106, and 108 via telecommunications links 110, 112, 114, and 116. This includes the data from the vehicles 108 and the slaughterhouse, grinding and distribution facilities described above in conjunction with FIGS. 6 and 7. These facilities each have the same tables in their mass storage devices as the tables shown in the mass storage devices of computer 212, and send all the data they are described as collecting to central computer 212.

In an alternative embodiment, the tables in each of the remote satellite facilities may be different in their actual table structure from the tables in the other remote satellite facilities and the central computer facilities. For example, different software vendors may gather and associate essentially the same data that is described above but structure it differently in data structures more appropriate for the facility that is being used. In this situation, the central computer is configured to receive data from the remote satellite facilities in disparate data structures, and map the data to the structures shown in FIG. 5.

The computer systems in the remote satellite facilities 102, 104, 106, and 108 are configured to transmit the data they have in their tables to computer 212 automatically and at regular predetermined intervals. These intervals are preferably at least once a day (24 hours), more preferably at least once a shift (8 hours), even more preferably at least twice a shift (4 hours), even more preferably at least four times a shift (2 hours), and most preferably at least once in 15 minutes).

As shown in block 804, the computer examines this data to determine whether a contamination condition exists. The computer 212 is configured to retrieve records in event tables from more than one facility, and each facility may have testing events in those event table records. Thus, as a part of its examination of table data, computer 212 is configured to search the event tables of a plurality (preferably all) of the remote facilities to determine whether any testing events have occurred at any of these facilities. In the event that testing events have occurred, computer system 212 reviews the record of each testing event to determine whether a test has revealed a contamination condition, or more generally, revealed a need to forward track or backtrack through the table data.

Computer 212 searches through the Event Table records until it finds a test event record. Once found, it compares the result field of that testing event with an internal value indicative of contamination. As just one of a myriad possible examples, if the test record is for an e.coli 157 test, and if the e.coli 157 count is greater than a predetermined level “X”, then computer 212 signals a contamination condition and proceeds to execute its contamination subprogram. The contamination subprogram is a program that is selectively executed by computer 212 whenever computer 212 determines that a food item has failed a test as described in this paragraph.

Computer 212 is configured to check the records it receives for a plurality of different contamination tests, and for each test it has a different threshold that can trigger the execution of its contamination subprogram. These multiple values are rules against which the test records are compared. From this it should be clear that the central computer system 212 is configured to receive a plurality of test results for a plurality of different types from a plurality of remote satellite processing and distribution facilities, and compare each of the different tests and the different test types with a unique corresponding test threshold value.

Once computer 212 determines that a contamination condition has occurred (or more generally, that a threshold test condition has been met, or met and exceeded) computer 212 is configured to execute the contamination subprograms. In the preferred embodiment the contamination subprogram is the one described below. There may be several such programs, however. Indeed, each threshold test condition that is met or exceeded may be associated with its own subprogram, and therefore there may be as many different subprograms as there are test rules.

The preferred subprogram, however, is the one illustrated at block 806 to block 812 in FIG. 8. In block 806, computer 212 first executes a forward search through the table data communicated to computer 212 from the plurality of remote satellite facilities.

Each test record in that data identifies the food item that was tested by its foodItemID, including the foodItemID of the test record that failed the test. To forward track through this data, the computer 212 is configured to search through the Event Table, the Combine Table and the Subdivide Table, entering the table with the foodItemID and searching all table records to determine if that foodItemID was ever subsequently subdivided, moved from location to location, or combined with other food items.

As an example, consider that the food item ID was for a clean carcass at the slaughterhouse. Based on the slaughterhouse records alone, computer 212 can forward track on the clean carcass foodItemID and find the subdivision of the carcass into scraps in combo bins and prime cuts. From the carcass foodItemID it is configured to find the combo bin foodItemID. From the combo bin foodItemID it is configured to find the departure record from the slaughterhouse.

From the foodItemID for the combo bin and the departure record (both received from the slaughterhouse) it is configured to track the carcass (now in a combo bin) to vehicle 108 from the vehicle 108 records. Computer 212 will determine the successive locations of the combo bin on its travels in vehicle 108 from the vehicle 108 records. Computer 212 will determine the arrival location, date and time from the vehicle 108 records.

From the vehicle 108 records, the computer will find the arrival event record for the arrival of the combo bin at the grinding facility. From the grinding facility records, the computer 212 traces the combo bin forward to the combine event when the ground scraps in the combo bin are combined with the ground scraps in the other combo bins in the meat patty forming machine. From the meat patty forming machine, the computer traces the meat further to the boxes of patties formed from the meat in the patty forming machine. Once it knows the foodItemID's for the individual boxes, it can search the grinding facility records and find a departure event when the boxes were shipped to the distribution facility. Knowing the departure event, the computer can search the vehicle 108 records to find an arrival event for the boxes' arrival in the vehicle 108 at the grinding facility. Transferring its search now to the new records provided by vehicle 108, the computer can search those records until it determines the boxes departed the vehicle at the distribution facility. Having determined that the meat from the carcass is in the boxes art the distribution facility, the computer wills search the records it received from the distribution facility for the foodItemID's of the boxes and further trace them through the system,

Thus, the computer has enough data and processing ability to search forward in time both by food item ID and by location, and to detect all subdivisions and combinations of a base foodItemID, and to determine the current location and configuration (patties, combo bins, hoppers, boxes of patties, etc.) of all the food items in the system. Computer 212 is configured to do this whenever the computer 212 is provided with a particular food item ID, such as a food item ID of an item that failed a test, for example.

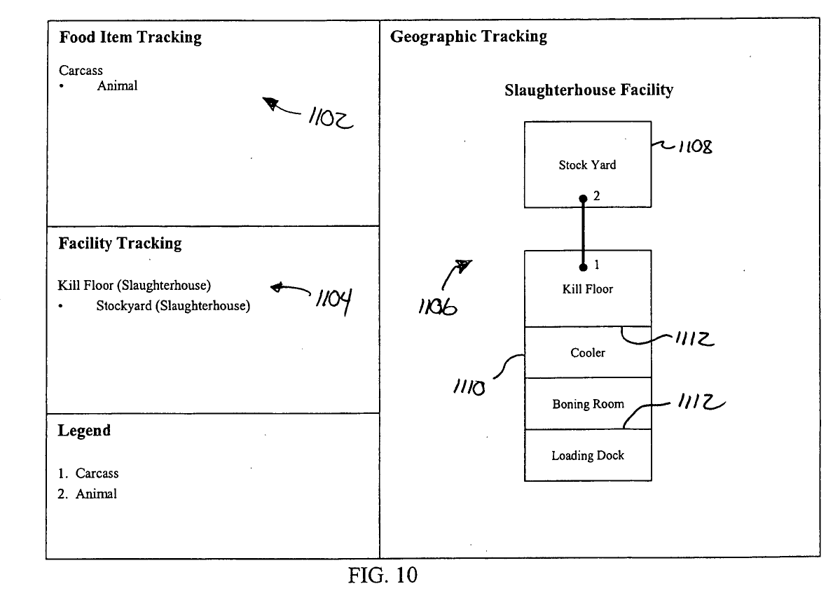

Computer 212 is also configured to display this forward trace information on the computer display 208 in central facility 100 as well as shown in block 808. FIG. 10 illustrates display 208 as it would appear if the carcass in the example had failed the test and the forward tracing occurred as described above.

In graphics area 1002, computer 212 drives display 208 to display a hierarchical list of the forward traced food items derived from the carcass that failed the test. The root of this hierarchical list is list item 1005 for the clean carcass itself. List item 1006 indicates the various prime cuts that were removed from the clean carcass (see above for description of the removal process), as well as the carcass scrap.

Since the carcass was subdivided into each of these items at the same time, they all share the same level in the graphical hierarchy: they are all indented to the same degree, and share the same logical level.

Further indented under scrap are the additional food items into which it was subdivided. For example, the hopper that received the ground meat from the combo bins is displayed. Nested underneath the hopper and indented is the patty forming machine, which received the hopper of meat and turned it into patties. Nested underneath the forming machine and indented are the three boxes of meat patties, “Box A”, “Box B”, and “Box C, that were formed from the meat in the patty forming machine. Each of these boxes of meat patties will have some portion that is from the clean carcass we are tracking, and thus are descendants of the contaminated carcass. In this example, only three boxes of meat patties were formed from the meat of the contaminated carcass and therefore all three are listed

Not all of the food items shown in the hierarchical list of region 1002 need be in existence at the time the forward searching is done. In this example, food items that have already ceased to exist are shown, such as the carcass, the combo bin, the hopper, the patty forming machine load of meat, and (perhaps) some or all of the boxes. In an alternative embodiment, computer 212 is configured to alternatively show or hide the food items that are not in existence by operating manipulation of to make the job of searching for contaminated food less confusing. In a preferred mode, the operator would press a button on the terminal that would signal computer 212 to show or to hide the non-existent food items in the hierarchical list of 1002.

In graphics area 1003, computer 212 drives display 108 to display a hierarchical list of the forward traced food item locations for all food items derived from the carcass that failed the test. These food items are shown in hierarchical form in region 1002 of the display screen. The root location is the slaughterhouse, since that is where the contaminated sample was taken. Indented underneath his location are two other locations, Restaurant A and the Packing Plant where the scraps were ground.

The root of this hierarchical list is list item 1007, shown as “slaughterhouse”, which is the location at which the test was performed on the carcass, also the test that the carcass failed. List item 1009 indicates the next location to which the contaminated food item (or parts thereof) was sent is Restaurant A. Restaurant A (not mentioned above) received the prime cuts from the contaminated carcass and thus is at the same level of indentation as the Packing Plant, which received the combo bins from the Slaughterhouse. Restaurant A also has a computer system such as 102, 104, or 106 that is configured to transmit data to the central facility as do the computers of the slaughterhouse and grinding facility (here called a “packing house”). The central computer is configured to search the data to identify the last known location of the prime cuts as Restaurant A.

Indented underneath the Packing House is the distribution center. This indicates that the Distribution Center received the boxes of meat “A”, “B” and “C” from the Packing Plant. Indented underneath the Distribution Center are the three locations that received the three boxes of meat from the distribution center. Since each of these three locations or facilities received the meat directly from the Distribution Center, they are at the same level of indentation underneath the Distribution Center. These three facilities or locations were not discussed above. Nonetheless, they received boxes “A”, “B” and “C”, respectively. These stores and restaurant are configured as remote satellite facility 102, 104, or 106 to receive data regarding their food items in table form and transmit that table data to the central computer in the same manner as the slaughterhouse and the grinding facility discussed above.

Graphics area 1004, illustrates the facility information in a spatial relationship. There are seven facilities represented on the screen by indicia at seven coordinates. These seven coordinates correspond to the latitude and longitude of the three facilities through which the food items passed, whether those food items or facilities are currently in existence or not. Indicia 1006 represent the slaughterhouse, indicia 1008 represent the grinding facility, indicia 1010 represent the distribution facility, indicia 1012 represent Restaurant A, indicia 1014 represent Grocery Store A, indicia 1016 represent Grocery Store B, and indicia 1018 represent Restaurant B.

These indicia indicated the locations where food items in the forward tracked chin of food items used to exist or currently exist at the time the test results were returned and computer system 212 calculated and displayed the forward path.

Each of the facility indicia are coupled together with straight line segments. these line segments represent the vehicles 108 that carried the food items from facility to facility. At this level of zoom, they do not indicate the exact paths of travel, merely straight line segments that couple the facility indicia on the screen.

Returning back to the process flow depicted in FIG. 8, once the computer 212 has displayed the forward searching map (shown in FIG. 9), it is then configured to automatically backtrack from the contaminated food item (the carcass identified in step 810 of FIG. 8) to all the food items from which the carcass was derived, and also to all the locations where those food items were located.

The process of backtracking is the reverse of the process of forward-tracking described above. To backtrack, computer 212 again starts with the failed test result event from the Event Table sent from the slaughterhouse. Instead of tracing forward, however, it tracks backward through the records. From the failed test result, it determines the clean carcass foodItemID number. With that number it searches the Event Table for the combine event and the associated Combine Table records to find the foodItemID numbers for the animal from which the clean carcass came. It also searches the arrival and departure event records to determine its location at each step of the way.

With this information, the central computer 212 is configured to track the carcass back to the stockyard of the slaughterhouse in which it was placed when it arrived at the slaughterhouse identified by the arrival records that was transmitted to computer 212 from the slaughterhouse computer system. If the animal arrived from a feedlot or ranch that was also a facility 102, 104, or 106 on the system by a vehicle 108 also on the system, the records from the feedlot or ranch as well as the vehicle transporting the animal from the feedlot or ranch would both have been transferred to central computer 212. The computer 212 would search through its vehicle records until it found a departure record for the animal's foodItemID indicating the animal had departed the truck, and an arrival record for the same animal identifying the location where the animal was loaded onto the vehicle. Computer 212 is configured to iterate this process, backtracking from foodItemID number to foodItemID number until it gets to the ultimate source of the animal—or at least back to the first facility on the system that ever held the animal in question.

Computer 212 then drives display screen 208 to display the results of this backtracking (see block 812). As shown in FIG. 10, graphics area 1102 is the same area of display 108 as graphics area 1002 of FIG. 9. It shows the backtracking done and represented in a hierarchical tree structure structured the same as the hierarchical tree structure of screen area 1002.

The highest and furthest outdented structure of region 1102 is the contaminated food item itself, the clean carcass. Indented beneath that list item are the food items from which the carcass descended, starting with the closest previous food item to the clean carcass in time: the animal. Since the animal was the first food item maintained in the RDS of central computer 212, it is the oldest and earliest item in the system from which the contaminated item can be traced, and hence it is the only other entry that can be made in the food item backtracking hierarchical list of food items.

On display screen 108, region 1104 is located in the same position as region 1003 shown in FIG. 9, and it illustrates the same information: the hierarchical list of locations through which the contaminated food item or its related food items have traveled. The difference between FIG. 9 and FIG. 10 is the type of tracing that is illustrated. Region 1104 illustrates the locations through which the contaminated food item is backtracked, and region 1003 illustrates the locations through which the food item is forward tracked. Since the only locations are (1) the killing floor at the slaughterhouse where the carcass was tested, and (2) the stockyard at the slaughterhouse where the animal was first received and logged into the system with an arrival event, there are only two entries in the hierarchical list of locations: the killing floor and the stockyard. Note that these two locations are within the same processing facility. The same-facility locations are less than 2 kilometers apart. More preferably they are less than 1 kilometer apart. Even more preferably they are less than 500 meters apart. By providing different locations on the scale of less than 500 meters to less than 2 kilometers, contamination can be localized not just to a facility, but to a small location within that facility. This enhances the ability for the quality control department of a facility to locate and clean up sources of contamination quickly and easily.

FIG. 10 also illustrates the hierarchical and spatial relationships of the two backtracked locations in screen region 1106. Region 1106 is in the same location on display 108 as region 1004 of FIG. 9. The content of the regions is different however. Region 1106 displays the two backtracked locations on the screen coupled by a line segment symbolically standing in for the path the food item (the animal, in this case) traveled from one location to the other. Note that the path of travel is not a road between two facilities such as shown in region 1004 of FIG. 9, but is a path through a building or between adjacent buildings.

Note that the elements displayed in region 1106 surrounding the locations and the line segment coupling them are not symbolic representations of political boundaries, such as the state boundaries shown in region 1004, but are walls and partitions that define exterior and interior areas of the slaughterhouse, including a fence 1108 that extends around the stockyard, external walls 1110 of the slaughterhouse and internal walls 1112 of the slaughterhouse.

Note that the scale of the map shown in region 1106 is also of radically different than the scale of region 1004. Region 1004 and 1106 are two dimensional regions or maps, yet the scale of region 1104 is about 1000 kilometers per inch, and the scale of region 1106 is about 100 meters per inch. They differ by a factor of 10,000.

In the preferred embodiment, computer 212 is configured to let the operator select the scale factor manually using the keyboard (the operator input device) associated with display 108. in this way, the operator can identify regional trends on contamination, and then zoom in to see whether particular areas in a processing or distribution plant contribute to the problem. In the preferred embodiment, computer 212 is configured to initially and automatically zoom to a level that will display all the locations.

In the examples above, the backtracking was limited since in the detailed example he backtracking only extended from the killing floor to the stockyard. The system is no limited to test results from a killing floor, however, but from any location or time during the production of food. As an example, each of the satellite computer systems are configured to record and transmit test results for any of he food items in a chain of production, including animal tests, carcass tests, combo bin tests, hopper tests, patty forming machine tests, boxed meat patty tests, hide tests, entrail tests, and prime cut tests, among others. A food item can therefore be tested at any of a plurality of points along its production and distribution process and computer 212 can forward trace or backward trace from any food item in the production and distribution process.

A further capability of the system is in backtracking from a single contaminated food item to a first plurality of constituent food items from which the contaminated food item was derived, and for each of those first constituent food items, backtracking to another plurality of constituent food items from which each of them is comprised.

Related to this is the system's capability to backtrack from a single system location (typically the location where the contaminated food item was found) to a first plurality of locations that previously housed constituent food item portions of the contaminated food item. And for each of those first plurality of locations, the system is capable of further backtracking to a plurality of locations that contained food item portions of each of the constituent food item portions.

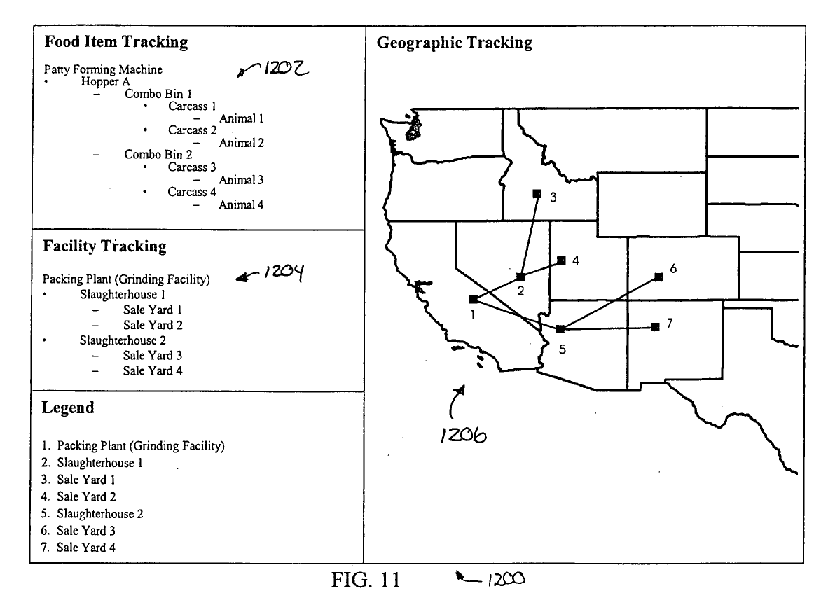

These capabilities are illustrated in FIG. 11, which shows the results of another contamination backtrack performed by computer 212. In the example of FIG. 12, computer 212 received a test result performed on the batch of meat placed in the patty forming machine. Since the test was performed on the contents of the patty forming machine it was performed at the grinding facility. The Event Table (including the test results) were sent to central computer 212 over the communications link (which may be 110, 112, or 114) between the grinding facility (which may be any of 102, 104 or 106) and the computer of central facility 100.

The test result from the Event Table of the grinding facility's computer would identify the patty forming machine and indicate that it failed the test.

In this example, the patty forming machine was filled with ground scraps from Hopper A, which in turn received ground scraps from two combo bins, Combo Bin 1 and Combo Bin 2. Combo Bin 1 was filled with carcass scraps from Carcass 1 and Carcass 2, which were taken, respectively, from Animal 1 and Animal 2. Combo Bin 2 was filled with carcass scraps from Carcass 3 and Carcass 4, which were taken, respectively, from Animal 3 and Animal 4. Each of these steps was recorded in the computer tables of the slaughterhouses and the grinding facility as subdivide events, testing events, combine events, arrival events and departure events as described above in more detail.

Furthermore, and unlike the detailed example above, the example of FIG. 11 illustrates a system in which there are five additional facilities: four sale yards and an additional slaughterhouse. A sale yard is a facility where cattle are brought in truckloads from what may be many ranches, feed lots, and farms to be sold. Each of the four sale yards in FIG. 11 is a facility 102, 104, or 106 on the system and provides at the very least the table data for arrival and departure events for each animal passing through that sale yard. This data, like the data from the slaughterhouse and the grinding facility is sent to the central computer 212 which receives it and searches it in the same manner as the slaughterhouse, grinding facility and distribution facility to determine the ultimate sale yard source of each animal backtracked.

In a similar fashion, the system also has an additional slaughterhouse, Slaughterhouse 2, which processes meat and communicates with the central computer 212 in an identical manner to that of the first slaughterhouse described above, herein denominated Slaughterhouse 1.

In the example shown in FIG. 11, Animal 1 was transferred from Sale Yard 1 to Slaughterhouse 1, Animal 2 was transferred from Sale Yard 2 to Slaughterhouse 1, animal 33 was transferred from Sale Yard 3 to Slaughterhouse 2, and animal 4 was transferred from Sale Yard 4 to Slaughterhouse 2. Computer 212 received the corresponding table records indicating the departures from the sale yards and the arrivals at the slaughterhouses.

Screen display 1200 of display 208 is subdivided into three sub-regions 1202, 1204 and 1206, respectively representing a hierarchical list of backtracked food items, a hierarchical list of backtracked food item facility locations of the food items in region 1202, and a two dimensional array of the facilities of region 1204 showing their locations at coordinates corresponding to their approximate positions on a map.

Region 1202 illustrates the hierarchical list of food items backtracked from the exemplary contaminated meat in the patty making machine at the grinding facility called “Packing House”. The deepest item or node on the list is the meat in the patty forming machine. The next item is indented underneath the machine and represents food item Hopper A that provided the contaminated meat to the patty forming machine. The next two food items on the list are indented underneath Hopper A and represent Combo Bin 1 and Combo Bin 2 that provided the meat to Hopper A. Each of these two combo bin items have two pairs of carcass food items indented underneath them: Carcass 1, Carcass 2, Carcass 3 and Carcass 4. Each of these food items have a corresponding animal from which the carcass came that is indented under each of them: Animal 1, Animal 2, Animal 3, and Animal 4.

Region 1204 of display 208 shows a hierarchical list of backtracked locations, starting with the location where the contamination was detected and proceeding through the locations from which the predecessors of the contaminated food item were. These locations are discovered by computer 212, which drives display 208 as it searches through the tabular data transmitted to it from the remote satellite facilities, which include the sale yards, the slaughterhouses and the grinding facility (or Packing Company) of FIG. 11. This backtracking through the table data occurs in the same manner as described in conjunction with the preceding example of FIG. 10.

As in the examples of FIGS. 9 and 10, a two-dimensional spatial array of the locations of region 1204 is displayed in region 1206 of display 208. Just as computer 212 generates the previous two screen regions, it likewise drives display 208 to display the third region 1206. In region 1206, like the similarly positioned regions shown in FIGS. 9 and 10, computer 212 causes screen display 208 to show a spatial display of the different locations at which the contaminated food item or its predecessors in time existed. Each node or location on this two-dimensional map, as in the previous examples, is located relative to the other locations or nodes as they would appear if drawn on a map. The coordinates of each location or node correspond to the physical location of the facility on the face of the earth.

As in the previous examples, each node on the map is connected to adjacent nodes with straight line segments, each line segment reflecting the fact that one or more food items was conveyed from one connected node to the other connected node. Note that computer 212 has generated two sequential branches in the chain of travel. The grinding facility is connected to two slaughterhouses, illustrating a backward branching into the past. This reflects a first combine event, in which food items from two different facilities reached the grinding facility and were converted into one food item by joining. Note that each of these slaughterhouses itself has two additional connections that branch backward in time. These branches similarly indicate that each of the slaughterhouses receives a food item from two different sources, and converts those food items into a single food item by joining. In this case, each slaughterhouse is connected to two sale yards, each of which providing a single animal to be joined in a combo bin.

The above describes several preferred embodiments of the system. The claims below are intended to cover not just the embodiments described above but every embodiment falling within the scope of the claims below.

We claim:

1. A system for tracking contamination in food products through a food processing and distribution system, comprising:
a central computer system including at least one central computer that includes a central relational database system, said central relational database system including one or more data structures, said one or more data structures having a plurality of central records indicating the location and identity of a plurality of food items within said food processing and distribution system; and
first and second remote satellite computer systems disposed in first and second remote food processing or distribution facilities, respectively, said first system including at least a first computer and a first satellite relational database system, said first satellite relational database system including at least a first data structure, said at least a first data structure including a first plurality of records identifying a succession of first food items derived from one another, and wherein said second system including at least a second computer and a second satellite relational database system, said second satellite relational database system including at least a second data structure, said at least a second data structure including a second plurality of records identifying a succession of second food items received from said first facility, said second food items being derived from said first food items;
wherein said central computer system is configured to electronically receive said first plurality of records and said second plurality of records, and to associate said first and second plurality of records to establish a chain of said first and second food items both in space and time.

2. The system of claim 1, wherein the first and second remote satellite facilities are meat processing and distribution facilities.

3. The system of claim 2, wherein said food items are meat products and said plurality of central records include records indicating the location of said meat products.

4. The system of claim 3, wherein the first and second plurality of records include records indicative of test results performed on said food items.

5. The system of claim 4, wherein said test results are indicative of contamination of said meat products.

6. The system of claim 1 wherein said plurality of central records are derived from said first and second plurality of records.

7. The system of claim 6, wherein the first plurality of records include at least one record indicative of tests performed on a tested food item sampled at said first remote food processing or distribution facility., and further wherein said central computer is configured to determine which food items at said second facility were derived from said tested food item.

8. The system of claim 6, wherein said first plurality of records include records sufficient to forward track said food items from said first facility to said second facility based at least upon electronically associating a record from said first plurality of records that indicates contamination of a contaminated food item with a record from sid second facility indicating the presence of said contaminated food item or a descendant of said contaminated food item at said second facility.

9. The system of claim 6, wherein said central computer is configured to receive data from said first plurality of records that indicate the transformation of a food item at said first facility into at least second and third food items.

10. The system of claim 9, wherein said first plurality of records include at least a first record associating said first food item with a first numeric identifying value and at least second and third records associating said second and third food items with second and third numeric identifying values, respectively, and further wherein said first, second and third numeric identifying values are different.

11. The system of claim 10, wherein said first food item is a quantity of raw foodstuffs, and said transformation of said first food item includes severing said quantity of raw foodstuffs into a plurality of lesser quantities.

12. The system of claim 11, wherein said quantity of raw foodstuffs includes a first piece of raw meat, and further wherein said plurality of lesser foodstuffs include several pieces of raw meat severed from said first piece of raw meat.

13. A system for tracking contamination in food products through a food processing and distribution system, comprising a central computer system including at least one central computer that includes a central relational database system, said central relational database system including one or more data structures, said one or more data structures having a plurality of central records indicating the location and identity of a plurality of food items within said food processing and distribution system, wherein said central computer system is configured to electronically receive a first plurality of records and a second plurality of records, and to associate said first and second plurality of records to establish a chain of a first and a second food item both in space and time;
wherein said central computer system is configured to receive said first plurality of records from a first remote satellite computer system disposed in a first remote food processing or distribution facility, said first system including at least a first computer and a first satellite relational database system, said first satellite relational database system including at least a first data structure, said at least a first data structure including a first plurality of records identifying a succession of first food items derived from one another; and
wherein said central computer system is configured to receive said second plurality of records from a second remote satellite computer system disposed in a second remote food processing or distribution facility, said second system including at least a second computer and a second satellite relational database system, said second satellite relational database system including at least a second data structure, said at least a second data structure including a second plurality of records identifying a succession of second food items received from said first facility, said second food items being derived from said first food items.

14. The system of claim 13, wherein the first and second remote satellite facilities are meat processing and distribution facilities.

15. The system of claim 14, wherein said food items are meat products and said plurality of central records include records indicating the location of said meat products.

16. The system of claim 15, wherein the first and second plurality of records include records indicative of test results performed on said food items.

17. The system of claim 16, wherein said test results are indicative of contamination of said meat products.

18. The system of claim 13 wherein said plurality of central records are derived from said first and second plurality of records.

19. The system of claim 18, wherein the first plurality of records include at least one record indicative of tests performed on a tested food item sampled at said first remote food processing or distribution facility., and further wherein said central computer is configured to determine which food items at said second facility were derived from said tested food item.

20. The system of claim 18, wherein said first plurality of records include records sufficient to forward track said food items from said first facility to said second facility based at least upon electronically associating a record from said first plurality of records that indicates contamination of a contaminated food item with a record from sid second facility indicating the presence of said contaminated food item or a descendant of said contaminated food item at said second facility.

21. The system of claim 18, wherein said central computer is configured to receive data from said first plurality of records that indicate the transformation of a food item at said first facility into at least second and third food items.

22. The system of claim 21, wherein said first plurality of records include at least a first record associating said first food item with a first numeric identifying value and at least second and third records associating said second and third food items with second and third numeric identifying values, respectively, and further wherein said first, second and third numeric identifying values are different.

23. The system of claim 22, wherein said first food item is a quantity of raw foodstuffs, and said transformation of said first food item includes severing said quantity of raw foodstuffs into a plurality of lesser quantities.

24. The system of claim 23, wherein said quantity of raw foodstuffs includes a first piece of raw meat, and further wherein said plurality of lesser foodstuffs include several pieces of raw meat severed from said first piece of raw meat.
